(19) United States
(12) Patent Application Publication
(10) Pub. No.: US 2017/0205751 A1
(43) Pub. Date: Jul. 20, 2017

(54) Post-Processing Device Which Can Fold a Sheet

(71) Applicant: Konica Minolta, Inc., Tokyo (JP)

(72) Inventors: Yusuke HIRANO, Toyohashi-shi (JP); Isamu KUGIMIYA, Toyokawa-shi (JP)

(21) Appl. No.: 15/408,845

(22) Filed: Jan. 18, 2017

(30) Foreign Application Priority Data
Jan. 19, 2016 (JP) 2016-008186

(51) Int. Cl. G03G 15/00

(52) U.S. Cl. CPC G03G 15/6582

(57) ABSTRACT

A post-processing device performs a first and a second folding processes on a sheet. The post-processing device comprises a pair of conveying rollers on a first conveying path, a first pair of folding rollers at a downstream side of the pair of conveying rollers on the first conveying path to perform a second folding process on the sheet, a second pair of folding rollers on a second conveying path branched from the first conveying path between the pair of conveying rollers and the first pair of folding rollers, to perform a first folding process on the sheet, and a guide at a closure position which shuts the first conveying path, to guide the sheet conveyed from the pair of conveying rollers to the first pair of folding rollers.

The present U.S. patent application claims a priority under the Paris Convention of Japanese patent application No. 2016-008186 filed on Jan. 19, 2016, the entirety of which is incorporated herein by references.

### BACKGROUND OF THE INVENTION

Field of the Invention

This invention relates to a post-processing device and an image forming apparatus equipped with the post-processing device. More specifically, this invention relates to a post-processing device which folds a sheet and an image forming apparatus equipped with the post-processing device.

Description of the Related Art

As electrophotography image forming apparatuses, there are an MFP (Multi Function Peripheral) having a scanner function, a facsimile function, a copying function, a function of a printer, a data transmitting function and a server function, a facsimile device, a copying machine, a printer, and so on.

Post-processing devices which perform post-processing on a sheet printed by an image forming apparatus are known. A post-processing device is normally installed on an image forming apparatus. A post-processing device can perform a saddle stitching and a half-folding process on a plurality of sheets at the central part, a Z-folding process for folding a large sized page into a Z shape, a process for punching sheets, a process for stapling sheets, and so on.

Conventional folding devices are disclosed in the below Documents 1 to 3, for example. The below Document 1 discloses a Z-folding device comprises of a pair of conveying rollers, a second pair of folding rollers, and a first pair of folding rollers. The pair of conveying rollers is provided on the first conveying path which feeds a sheet to a process tray. The second pair of folding rollers is provided at a downstream side of the pair of conveying rollers, and forms the second folding line on a sheet on which Z-folding is to be performed. The first pair of folding rollers is provided on the second conveying path, wherein the second conveying path is branched from the first conveying path between the pair of conveying rollers and the second pair of folding rollers. The first pair of folding rollers forms the first folding line on a sheet on which the Z-folding is to be performed.

The below Document 2 discloses a sheet processing device comprises a stacking feeding paper path which stores conveyed sheets, a butting part for positioning the stored sheets on the stacking feeding paper path by supporting the end of the sheets in the conveying direction, a folding roller for forming a folding line in the width direction perpendicular to the sheet conveying direction by holding the sheet by a nip portion, and a hold unit for holding the sheets which were stored on the stacking feeding paper path and were supported by the butting part and feeding the sheets to the nip portion of the folding roller.

The below Document 3 discloses a sheet folding device comprises a first pair of folding rollers which makes a first folding line on a sheet, a second pair of folding rollers which makes a second folding line on the sheet, a first stopper part for positioning the conveyed sheet by butting the leading end of the conveyed sheet in the conveying direction, a second stopper part for positioning the conveyed sheet by butting the first folding line of the sheet, and a sheet press unit to assist the sheet to form a slack on the sheet and guide the slack to a nip portion the second pair of folding rollers. The sheet press unit has a contact part which makes contact with the sheet, and a supporting part which is flexible and supports the contact part swingably.
[Document 1] Japan Patent Publication No. (HEI) 09-124227
[Document 2] Japan Patent Publication No. 2012-111567
[Document 3] Japan Patent Publication No. 2011-236017

However, according to the technique described in Document 1 etc., the first pair of folding rollers faces the first conveying path. Hence, there is a risk that a sheet makes contact with the first pair of folding rollers, to cause a paper feeding defect, when a sheet on which the folding process is not performed passes through the first conveying path, or when a leading end of a sheet before the first folding line is formed is guided to the nip of the second pair of folding rollers.

### SUMMARY OF THE INVENTION

This invention is to solve the above problems. The object is to provide a post-processing device which has proper paper feeding performance, and an image forming apparatus equipped with the post-processing device.

According to one aspect of this invention, a post-processing device capable of performing a first and a second folding processes on a sheet, comprises a pair of conveying rollers installed on a first conveying path for conveying the sheet, a first pair of folding rollers which is installed at a downstream side of the pair of conveying rollers on the first conveying path, for performing the second folding process on the sheet, a second pair of folding rollers which is installed on a second conveying path for conveying the sheet, which is branched from the first conveying path between the pair of conveying rollers and the first pair of folding rollers, for performing the first folding process on the sheet, and a guide part which is installed at a closure position which shuts the first conveying path, for guiding the sheet conveyed from the pair of conveying rollers to the first pair of folding rollers, wherein the closure position is a position where the guide part shuts the first conveying path against an area between a location which is a nearest location from the first conveying path on a circumference of one roller of the second pair of folding rollers and a location which is a nearest location from the first conveying path on a circumference of another roller of the second pair of folding rollers.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 schematically shows an appearance of image forming apparatus 100, according to the embodiment of this invention.

FIG. 2 shows a cross sectional view roughly indicating a structure adjacent to folding device 40 of post-processing device 51 of FIG. 1.

FIG. 3 shows a cross sectional view indicating a structure of folding device 40, according to the embodiment of this invention.

FIG. 4 shows a block diagram indicating a functional structure of image forming apparatus 100, according to the embodiment of this invention.

FIG. 5 shows a cross sectional view indicating the first behavior of post-processing device 51, according to the embodiment of this invention.

FIG. 6 shows a cross sectional view to explain closure position P61 of movable guide 6, according to the embodiment of this invention.

FIG. 7 shows a cross sectional view indicating the second behavior of post-processing device 51, according to the embodiment of this invention.

FIG. 8 shows a cross sectional view indicating the third behavior of post-processing device 51, according to the embodiment of this invention.

FIG. 9 shows a cross sectional view indicating the fourth behavior of post-processing device 51, according to the embodiment of this invention.

FIG. 10 shows a cross sectional view indicating the fifth behavior of post-processing device 51, according to the embodiment of this invention.

FIG. 11 shows a cross sectional view indicating the sixth behavior of post-processing device 51, according to the embodiment of this invention.

FIG. 12 shows a cross sectional view indicating the seventh behavior of post-processing device 51, according to the embodiment of this invention.

FIG. 13 shows a cross sectional view indicating the eighth behavior of post-processing device 51, according to the embodiment of this invention.

FIG. 14 shows a cross sectional view indicating the ninth behavior of post-processing device 51, according to the embodiment of this invention.

FIG. 15 shows a cross sectional view indicating the tenth behavior of post-processing device 51, according to the embodiment of this invention.

FIG. 16 shows a cross sectional view indicating the eleventh behavior of post-processing device 51, according to the embodiment of this invention.

FIG. 17 shows a cross sectional view indicating the twelfth behavior of post-processing device 51, according to the embodiment of this invention.

FIG. 18 shows a cross sectional view indicating the thirteenth behavior of post-processing device 51, according to the embodiment of this invention.

FIG. 19 shows a cross sectional view indicating the fourteenth behavior of post-processing device 51, according to the embodiment of this invention.

FIG. 20 shows a cross sectional view indicating the fifteenth behavior of post-processing device 51, according to the embodiment of this invention.

### DESCRIPTION OF THE PREFERRED EMBODIMENTS

Hereinafter, an embodiment of the present invention will be described with reference to the drawings. However, the scope of the invention is not limited to the illustrated examples.

In the followings, the embodiments of this invention will be explained with the FIGs.

In the following embodiments, a post-processing device which is a part of an image forming apparatus will be explained. The image forming apparatus may be an MFP, a printer, a copying machine, a facsimile, or the like. The post-processing device may be designed separating from a main body of the image forming apparatus. The post-processing device may be attachable to/detachable from the main body of the image forming apparatus, as needed basis.

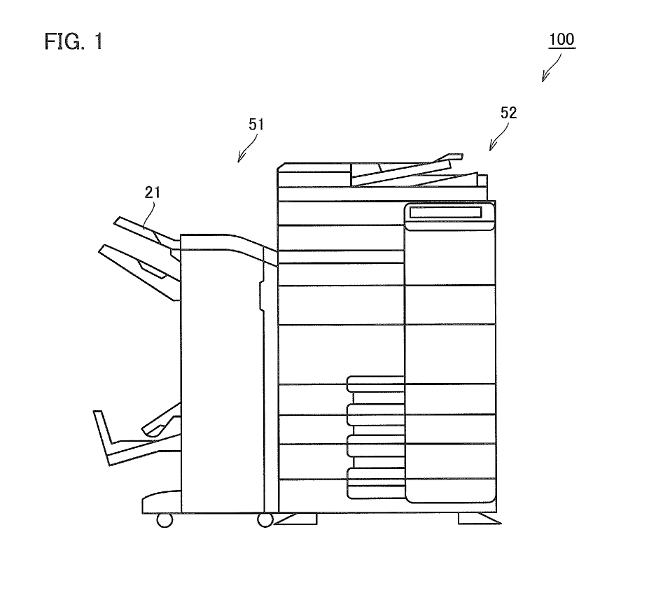

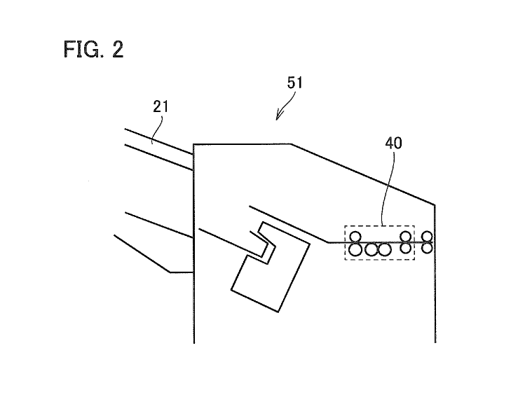

FIG. 1 schematically shows an appearance of image forming apparatus 100, according to the embodiment of this invention. FIG. 2 shows a cross sectional view roughly indicating a structure adjacent to folding device 40 of post-processing device 51 of FIG. 1.

Referring to FIGS. 1 and 2, the image forming apparatus 100 according to the embodiment is equipped with post-processing device 51, and a main body 52 of the image forming apparatus. The main body 52 of the image forming apparatus performs printing on sheets. Post-processing device 51 includes folding device 40 and so on. Folding device 40 is provided in an inner part of a chassis of post-processing device 51. Post-processing device 51 can perform a Z-folding process (an example of a first and a second folding processes) on a sheet printed by the main body 52 of the image forming apparatus, by using folding device 40.

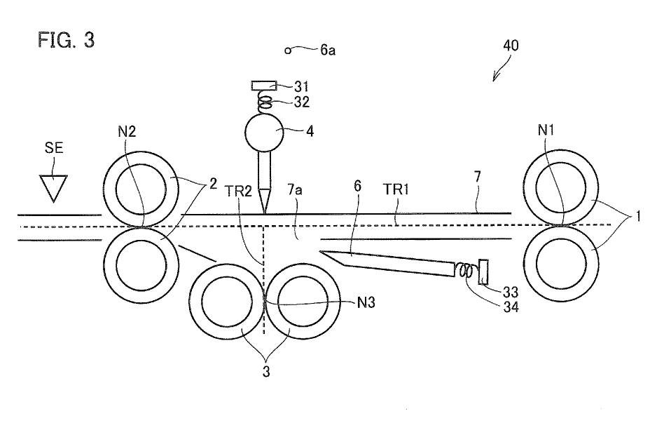

FIG. 3 shows a cross sectional view indicating a structure of folding device 40, according to the embodiment of this invention.

Referring to FIG. 3, folding device 40 includes a pair of conveying rollers 1, a pair of folding rollers 2 (an example of a first pair of folding rollers), a pair of folding rollers 3 (an example of a second pair of folding rollers), folding guide 4 (an example of a folding part), movable guide 6 (an example of a guide part), sheet guide 7, and sensor SE.

The pair of conveying rollers 1 is placed on conveying path TR1 (an example of a first conveying path) on which sheets are conveyed. The pair of conveying rollers 1 is rotationally driven, to pinch a sheet by nip N1 and convey it along with conveying path TR1.

The pair of folding rollers 2 is placed at a downstream side of the pair of conveying rollers 1 on conveying path TR1. The pair of folding rollers 2 is rotationally driven, to pinch a sheet by nip N2 and convey it along with conveying path TR1. The pair of folding rollers 2 performs the second folding process (the 2nd folding process) on a sheet on which a Z-folding is to be performed, at nip N2.

The pair of folding rollers 3 is placed on conveying path TR2 (an example of a second conveying path). Conveying path TR2 is branched from conveying path TR1 between the pair of conveying rollers 1 and the pair of folding rollers 2. The pair of folding rollers 3 performs the first folding process (the 1st folding process) on a sheet on which a Z-folding is to be performed, at nip N3.

When performing the first folding process on a sheet on which a Z-folding process is to be performed, folding guide 4 guides the slack of the sheet to nip N3 of the pair of folding rollers 3. Folding guide 4 is movable between the evacuation position (an example of the first folding part position) and the folding position (an example of the second folding part position). The evacuation position and the folding position will be explained later in detail.

When a sheet on which a Z-folding process is not to be performed is conveyed along with conveying path TR1 or the like, movable guide 6 guides the sheet to nip N2 of the pair of folding rollers 2. When performing the second folding process on a sheet on which a Z-folding process is to be performed, movable guide 6 guides the slack of the sheet to nip N2 of the pair of folding rollers 2. Movable guide 6 is swingable (movable) around the fulcrum 6a, among the closure position, the evacuation position, and the guiding position. The closure position, the evacuation position, and the guiding position will be explained later in detail.

Sheet guide 7 guides a sheet to conveying path TR1. Sheet guide 7 has aperture 7a at the branching part of conveying path TR2 from conveying path TR1.

Sensor SE detects a sheet at a downstream side of nip N2 on conveying path TR1.

Post-processing device 51 is further equipped with fixing unit 31 to which folding guide 4 is fixed, energization part 32 installed between folding guide 4 and fixing unit 31, fixing unit 33 to which movable guide 6 is fixed, and energization part 34 installed between movable guide 6 and fixing unit 33. Post-processing device 51 drives fixing unit 31 to move folding guide 4. Post-processing device 51 drives fixing unit 33 to move movable guide 6.

In the pair of conveying rollers 1, one roller which forms the pair of conveying rollers 1 may be rotationally driven, and another roller may be driven by the one roller. Both the rollers which form the pair of conveying rollers 1 may be rotationally driven. The pairs of folding rollers 2 and 3 can be rotationally driven in the similar manner

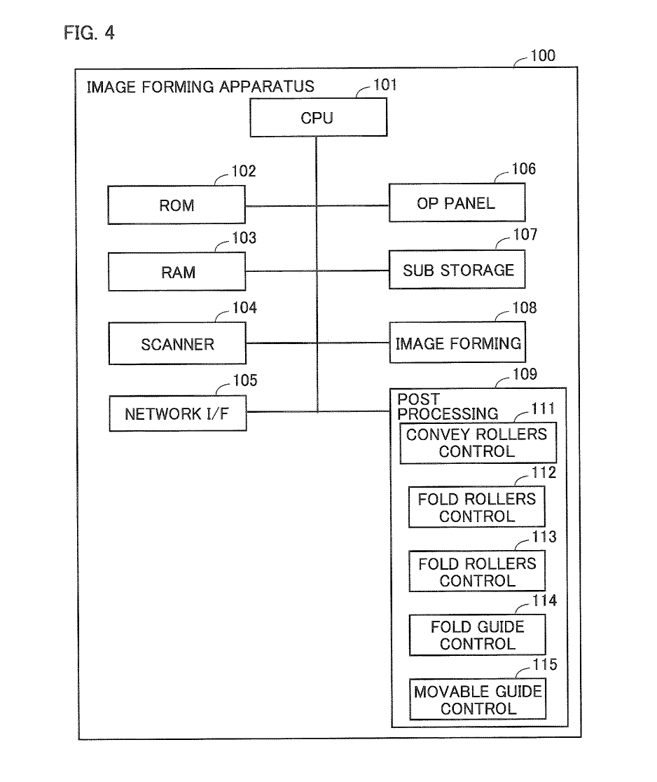

FIG. 4 shows a block diagram indicating a functional structure of image forming apparatus 100, according to the embodiment of this invention.

Referring to FIG. 4, image forming apparatus 100 includes CPU (Central Processing Unit) 101, ROM (Read Only Memory) 102, RAM (Random Access Memory) 103, scanner 104, network interface 105, operation panel 106, subsidiary storage device 107, image forming unit 108, and post-processing control unit 109. CPU 101, and each of ROM 102, RAM 103, scanner 104, network interface 105, operation panel 106, subsidiary storage device 107, image forming unit 108, and post-processing control unit 109 are bilaterally connected with each other, via a bus or the like.

CPU 101 works in accordance with control programs, and controls the entirety of image forming apparatus 100.

ROM 102 stores control programs.

RAM 103 is a working memory for CPU 101, to temporarily store various data.

Scanner 104 reads document images.

Network interface 105 transmits and receives information with external devices which are connected to image forming apparatus 100, via a network (which is not shown in FIGs.).

Operation panel 106 displays various information, and receives various operations.

Subsidiary storage device 107 stores various data, such as image data to be printed.

Image forming unit 108 performs printing on sheets in the inner part of the main body 52 of the image forming apparatus. Image forming unit 108 is roughly configured with a toner image forming unit, a fixing device, a sheet conveying unit, and so on Image forming unit 108 forms an image on the sheet by electrophotographic technology, for example. The toner image forming unit synthesizes four-colored images by so-called a tandem system, to form color images on sheets. The toner image forming unit is configured with photo conductors installed for colors of C (cyan), M (magenta), Y (yellow), and K (black), an intermediate transfer belt to which toner images are transferred (the primary transfer) from the photo conductors, a transfer unit to transfer an image from the intermediate transfer belt to a sheet (the secondary transfer), and so on. The fixing device has a heating roller and a pressure roller. The fixing device pinches and conveys a sheet on which a toner image was formed, by using a heating roller and a pressure roller, to heat and apply pressure on the sheet. Herewith, the fixing device melts toner adhered to the sheet to fix it on the sheet, to form the image on the sheet. The sheet conveying unit is configured with paper feeding rollers, conveying rollers, motors to drive the rollers, and so on. The sheet conveying unit feeds paper sheets from a feeding cartridge, and conveys the sheets in the inner part of the main body 52 of the image forming apparatus. The sheet conveying unit feeds sheets printed by the main body 52 of the image forming apparatus from the main body 52 of the image forming apparatus to the inner part of post-processing device 51.

Post-processing control unit 109 controls entire behavior of post-processing device 51 under the control of CPU 101. Post-processing control unit 109 includes the pair of conveying rollers control unit 111, the pair of folding rollers control unit 112, the pair of folding rollers control unit 113, folding guide control unit 114, and movable guide control unit 115. The pair of conveying rollers control unit 111 controls rotation of the pair of conveying rollers 1. The pair of folding rollers control unit 112 controls rotation of the pair of folding rollers 2. The pair of folding rollers control unit 113 controls rotation of the pair of folding rollers 3. Folding guide control unit 114 controls behavior of folding guide 4. Movable guide control unit 115 controls behavior of movable guide 6.

Next, the behavior of post-processing device 51 according to the embodiment will be explained. In the following FIGs., a structure of a part of post-processing device 51 may be shown, only when the explanation is needed.

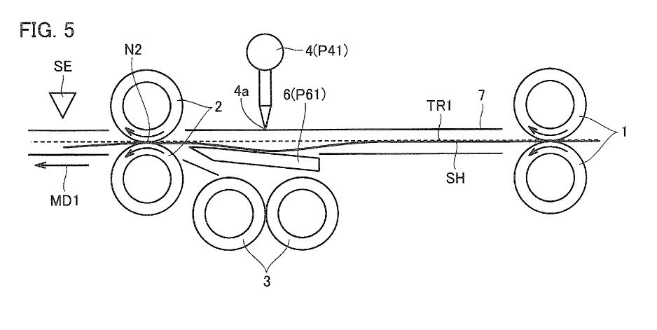

Referring to FIG. 5, image forming apparatus 100 feeds a sheet discharged from the main body 52 of the image forming apparatus into post-processing device 51, to convey it to the inner part of folding device 40.

When post-processing device 51 conveyed sheet SH into the inner part of folding device 40, post-processing device 51 rotates the pair of conveying rollers 1 and the pair of folding rollers 2, to convey sheet SH along with conveying path TR1. During this conveying, folding guide 4 is present at the evacuation position P41. At the evacuation position P41, leading end 4a of folding guide 4 is present at an upper side location of conveying path TR1 (the opposite side of conveying path TR1 to the pair of folding rollers 3). Movable guide 6 is present at closure position P61.

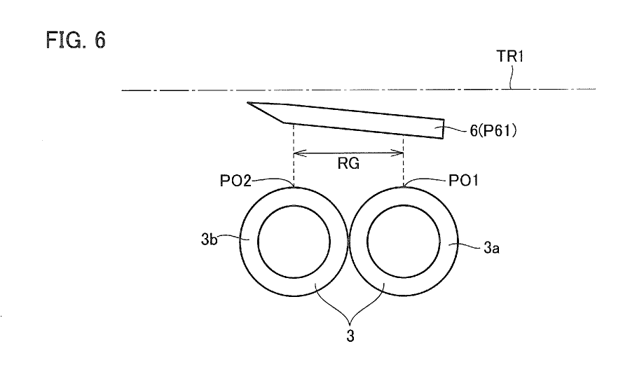

FIG. 6 shows a cross sectional view to explain closure position P61 of movable guide 6, according to the embodiment of this invention.

Referring to FIGS. 5 and 6, when movable guide 6 is present at closure position P61, movable guide 6 shuts conveying path TR1 against area RG between location PO1 and location PO2, wherein the location PO1 is a nearest location from conveying path TR1 on the circumference of one roller 3a of the pair of folding rollers 3, and the location PO2 is a nearest location from conveying path TR1 on the circumference of another roller 3b of the pair of folding rollers 3.

When movable guide 6 is present at closure position P61, movable guide 6 guides the leading end of the sheet conveyed from the pair of conveying rollers 1 to the pair of folding rollers 2. When movable guide 6 is present at closure position P61, the sheet being conveyed along with conveying path TR1 is prevented from making contact with the pair of folding rollers 3, so that a feeding paper defect can be prevented.

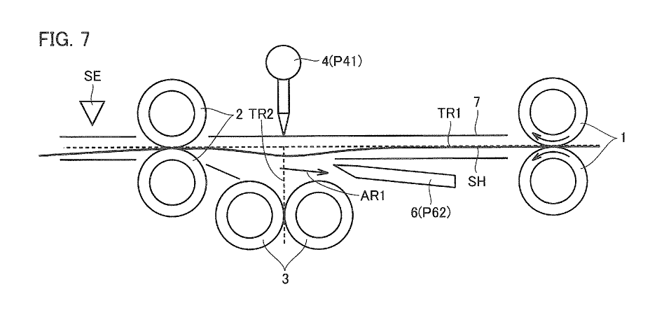

When a Z-folding process is not performed on sheet SH, post-processing device 51 makes the pair of conveying rollers 1 and the pair of folding rollers 2 keep rotating, in the state that movable guide 6 is present at closure position P61, to discharge sheet SH onto discharge tray 21 (FIG. 1) at a downstream side of nip N2 as shown by arrow MD1. On the other hand, when a Z-folding process is performed on sheet SH, post-processing device 51 performs behavior shown by FIGS. 7 to 20, after behavior of FIG. 5.

Referring to FIG. 7, when sensor SE detects the leading end of sheet SH, post-processing device 51 moves movable guide 6 in the direction shown by arrow AR1, to arrange movable guide 6 at evacuation position P62. The evacuation position P62 is an upstream side of closure position P61 on conveying path TR1. By moving movable guide 6 to evacuation position P62, at least a part of area RG is exposed to conveying path TR1.

At the timing when the leading end of sheet SH arrives at the predetermined location decided in response to a size of sheet SH or a type of the folding mode, post-processing device 51 stops rotation of the pair of folding rollers 2. The location of the anterior end of sheet SH is calculated based on the clock time when sensor SE detects the anterior end of sheet SH and the conveying velocity of sheet SH. After the pair of folding rollers 2 stops, post-processing device 51 continuously drives the pair of conveying rollers 1 rotationally.

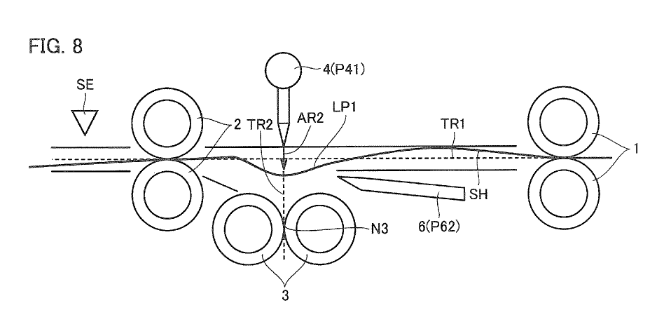

Referring to FIG. 8, since sheet SH is fed into the direction toward the pair of folding rollers 2 by the pair of conveying rollers 1, a slack (loop) LP1 is formed near the nip N3 on sheet SH. When the period of predetermined time t1 has elapsed after the pair of folding rollers 2 stopped, post-processing device 51 stops the pair of conveying rollers 1. Time t1 is configured such that a proper sized slack LP1 is formed on sheet SH based on types of sheet SH and the basis weight.

Since the slack LP1 is formed only by feeding of the pair of conveying rollers 1, the variation of the stopping positions of sheets can be decreased, as compared with the case in which a slack is formed by feedings of both of the pair of conveying rollers 1 and the pair of folding rollers 2.

Next, under the state in which movable guide 6 is arranged at the evacuation position P62, post-processing device 51 performs the first folding process. Post-processing device 51 begins to move folding guide 4 toward the folding position P42 adjacent to nip N3, as shown by arrow AR2. Post-processing device 51 guides the slack LP1 of sheet SH to nip N3, by pushing sheet SH by using folding guide 4.

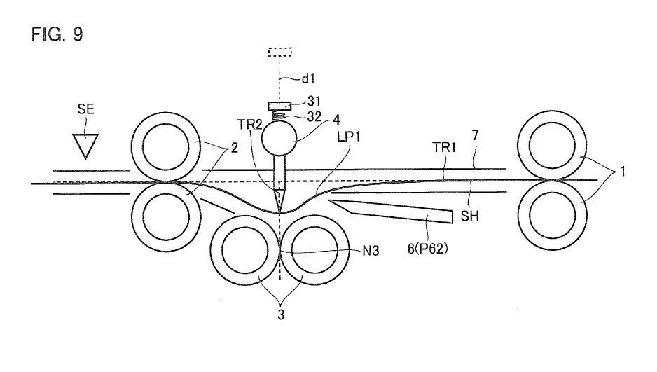

Referring to FIG. 9, post-processing device 51 moves fixing unit 31 by distance d1, to move folding guide 4. When folding guide 4 is moved, an apex of the slack LP1 is pushed by the lower end of folding guide 4, so that the apex becomes closer to nip N3. The tension of sheet SH increases so that the reaction force of sheet SH received by energization part 32 increases too. Before fixing unit 31 moves by distance d1, the tension of sheet SH and the energization force of energization part 32 are balanced with each other. After that, a part of the amount of the movement (distance d1) of fixing unit 31 is absorbed as the compression amount of energization part 32. In consequence, the amount of the movement of folding guide 4 at the time point shown by FIG. 9 is smaller than distance d1, and the compression amount of energization part 32 becomes larger than the amount before folding guide 4 starts moving. Namely, energization part 32 behaves as an escape mechanism for folding guide 4. By the effect of energization part 32, folding guide 4 is prevented from applying excessive force to sheet SH. Therefore, sheet SH can be prevented from being damaged.

The size of the slack LP1 before being pushed by folding guide 4 can be adjusted by time t1 as presented above. Hence, the size of the slack LP1 does not become excessively enlarged, as compared to the slack space (the space adjacent to nip N3). Therefore, creases and kinks do not occur on sheet SH, and the slack LP1 can be pushed by sufficient force of folding guide 4 at all times.

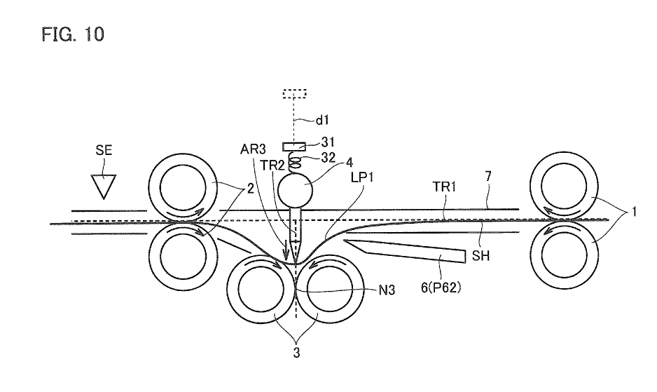

Referring to FIG. 10, in the state in which fixing unit 31 moved by distance d1 (in the state in which folding guide 4 pushes the slack LP1), post-processing device 51 rotates the pair of conveying rollers 1 and the pair of folding rollers 2 in the direction by which the slack LP1 of sheet SH is fed downward along with conveying path TR2. Post-processing device 51 rotates the pair of folding rollers 3 in the direction by which the slack LP1 of sheet SH is fed downward along with conveying path TR2.

When sheet SH is fed into nip N3, the slack LP1 enlarges, and the tension of sheet SH decreases. The energization force of energization part 32 becomes larger than the tension of sheet SH, and energization part 32 returns to the original length. By the energization force when energization part 32 returns to the original length, folding guide 4 moves toward nip N3 again, to press the slack LP1 as shown by arrow AR3.

Folding guide 4 finally arrives at the folding position P42. The folding position P42 at where folding guide 4 arrives may be an arbitrary location where the leading end 4a of folding guide 4 is present at the side of the pair of folding rollers 3 with respect to conveying path TR1. The folding position P42 may be a position to push sheet SH into nip N3, or be a position to guide sheet SH close to nip N3.

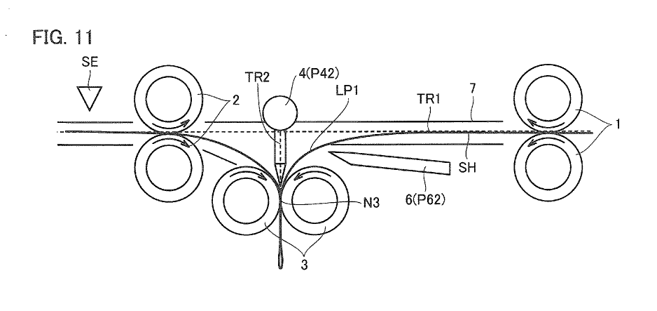

Referring to FIG. 11, after folding guide 4 was arranged at the folding position P42, nip N3 bites the slack LP1, so that the first folding line is formed on sheet SH (the first folding process).

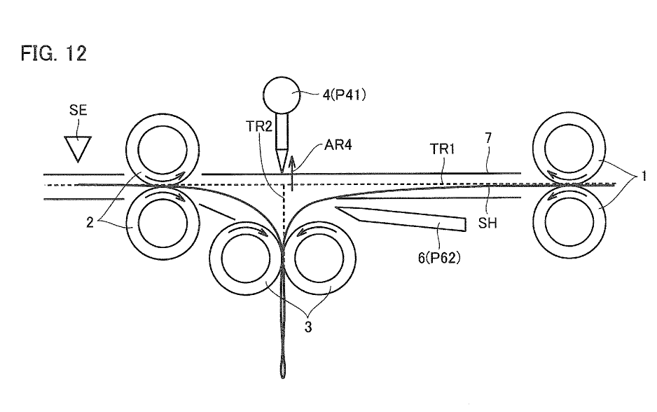

Referring to FIG. 12, after the first folding line was formed on sheet SH, post-processing device 51 moves folding guide 4 as shown by arrow AR4 to return it to the evacuation position P41.

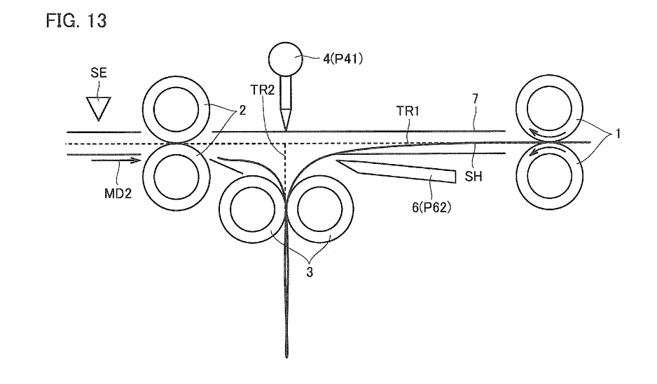

Referring to FIG. 13, when the first folding process, the leading end of sheet SH moves along with conveying path TR1 in the direction shown by arrow MD2. Hence, post-processing device 51 detects the leading end of sheet SH again by sensor SE. Post-processing device 51 stops the pairs of folding rollers 2 and 3, at the timing when the leading end of sheet SH arrives at the predetermined location which is decided based on the size of sheet SH and types of the folding mode. The location of the anterior end of sheet SH is calculated based on the clock time when sensor SE detects the anterior end of sheet SH and the conveying velocity of sheet SH. After the pair of folding rollers 2 stops, post-processing device 51 rotationally drives the pair of conveying rollers 1 continuously.

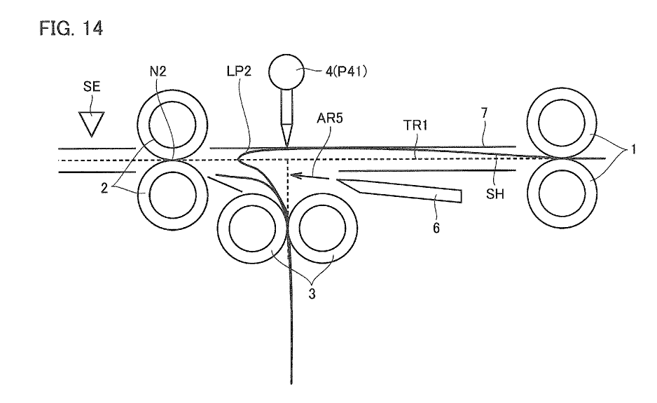

Referring to FIG. 14, since sheet SH is fed toward the pair of folding rollers 2 by the pair of conveying rollers 1, the slack (loop) LP2 is formed near nip N2 on sheet SH. When the period of predetermined time t2 has elapsed after the pairs of folding rollers 2 and 3 stopped, post-processing device 51 stops the pair of conveying rollers 1. Time t2 is configured such that a proper sized slack LP2 is formed on sheet SH based on types of sheet SH and the basis weight.

Next, in the state in which folding guide 4 is arranged at the evacuation position P41, post-processing device 51 performs the second folding process. Post-processing device 51 begins to move movable guide 6 toward the guiding position P63 adjacent to nip N2, as shown by arrow AR5. By pushing sheet SH by movable guide 6, post-processing device 51 guides the slack LP2 of sheet SH to nip N2.

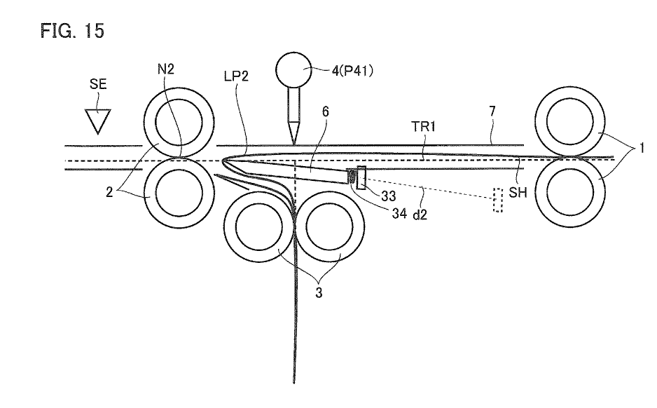

Referring to FIG. 15, post-processing device 51 moves fixing unit 33 by distance d2, to move movable guide 6. When movable guide 6 moved, an apex of the slack LP2 is pushed by the leading end of movable guide 6, to approach the nip N2. The tension of sheet SH increases, and the reaction force of sheet SH which energization part 34 receives increases too. Before fixing unit 33 moves by distance d2, the tension of sheet SH and the energization force of energization part 34 are balanced with each other. After that, a part of the amount of the movement (distance d2) of fixing unit 33 is absorbed as the compression amount of energization part 34. In consequence, the amount of the movement of movable guide 6 at the time point of FIG. 15 is smaller than distance d2, and the compression amount of energization part 34 becomes larger than the amount before movable guide 6 starts moving. Namely, energization part 34 behaves as an escape mechanism of movable guide 6. By the effect of energization part 34, movable guide 6 is prevented from applying excessive force to sheet SH. Hence, sheet SH is prevented from being damaged.

The size of the slack LP2 before being pushed by movable guide 6 can be adjusted by time t2 as presented above. Hence, the size of the slack LP2 does not become excessively enlarged, as compared to the slack space (the space adjacent to nip N2). Therefore, creases and kinks do not occur on sheet SH, and the slack LP2 can be pushed by sufficient force of movable guide 6 at all times.

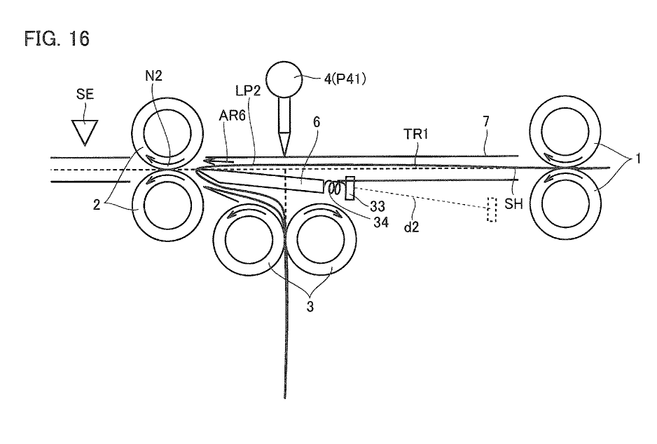

Referring to FIG. 16, in the state in which fixing unit 33 was moved by distance d2 (the state in which movable guide 6 presses the slack LP2), post-processing device 51 rotates the pair of conveying rollers 1 and the pair of folding rollers 2 in the direction in which the slack LP2 of sheet SH is fed into nip N2, and rotates the pair of folding rollers 3 in the direction in which sheet SH is fed into the upward.

When the slack LP2 of sheet SH is fed into nip N2, the slack LP2 enlarges, and the tension of sheet SH decreases. The energization force of energization part 34 becomes larger than the tension of sheet SH, and energization part 34 returns to the original length. By the energization force when energization part 34 returns to the original length, movable guide 6 moves toward nip N2 again, to push the slack LP2 further as shown by arrow AR6.

Movable guide 6 finally arrives at the guiding position P63. The guiding position P63 at where movable guide 6 arrives may be an arbitrary location being present at a downstream side of closure position P61 on conveying path TR1. The guiding position P63 at where movable guide 6 arrives may be a position which pushes sheet SH into nip N2, or a position which guides sheet SH near the nip N2.

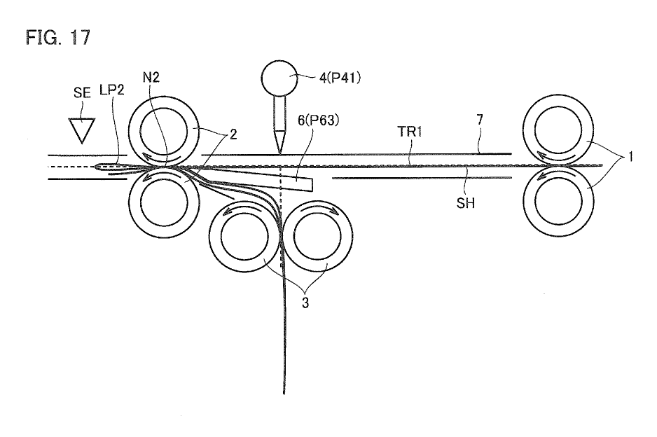

Referring to FIG. 17, after movable guide 6 was arranged at the guiding position P63, nip N2 bites the slack LP2, so that the second folding line is formed on sheet SH (the second folding process).

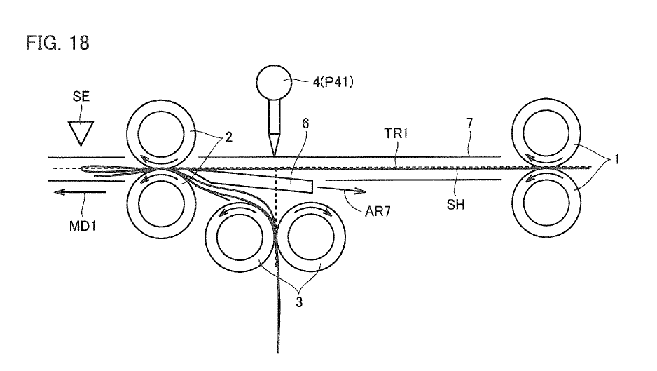

Referring to FIG. 18, after the second folding line was formed on sheet SH, sheet SH is conveyed by the pair of folding rollers 2, in the direction shown by arrow MD1. When sensor SE detects the leading end of sheet SH, post-processing device 51 moves movable guide 6 in the direction shown by arrow AR7 to arrange movable guide 6 at closure position P61, to provide for the next job.

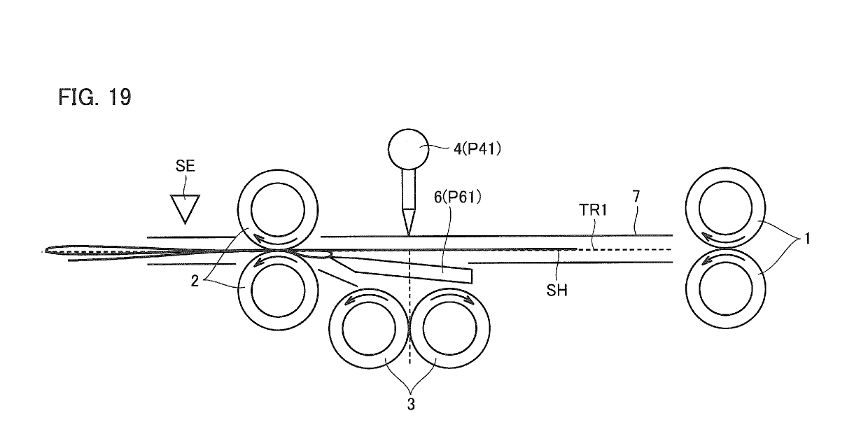

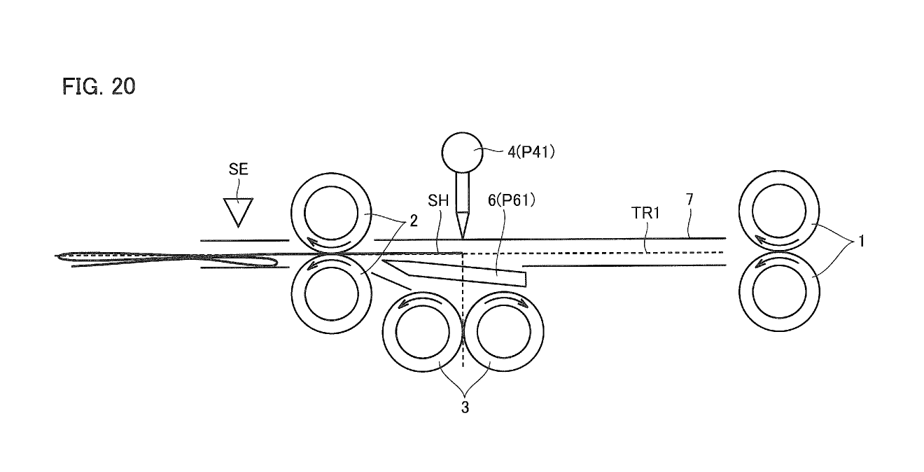

Referring to FIGS. 19 and 20, sheet SH on which the second folding line was formed (a Z-folded sheet) may be directly discharged onto discharge tray 21. A post-processing other than the Z-folding process, such as a stapling, a punching may be performed on the sheet SH on which the second folding line was formed.

[The effect of the embodiments]

According to the above embodiments, when sheet SH on which a folding process is not performed is conveyed along with conveying path TR1, or when the leading end of sheet SH before the first folding line is formed is guided to nip N2 of the pair of folding rollers 2, sheet SH is prevented from making contact with the pair of folding rollers 3. Therefore, good performance of feeding paper can be obtained.

When performing the first folding process on sheet SH, movable guide 6 moves to the evacuation position P62. Hence, good performance of feeding paper can be obtained, and the first folding process can be performed smoothly.

When performing the second folding process on sheet SH, movable guide 6 moves to the guiding position P63. Hence, by movable guide 6, the slack LP2 of sheet SH can be guided to nip N2. Herewith, the attitude of the slack LP2 of sheet SH before the second folding process can be stabilized regardless of the basis weight or the like of the sheet SH, so that the variation of the locations of the second folding lines can be easily (inexpensively) prevented. In particular, when movable guide 6 moves to the guiding position P63, the slack LP2 of sheet SH is pushed, to further stabilize the attitude of the slack LP2 of sheet SH before the second folding process.

Further, by providing energization part 34, sheet SH can be prevented from being damaged by movable guide 6 when sheet SH is pushed via the variation of sizes of the slack LP2 of sheet SH.

Further, when performing the first folding process on sheet SH, folding guide 4 moves to the folding position P42. Hence, by folding guide 4, the slack LP1 of sheet SH can be guided to nip N3. Herewith, the attitude of the slack LP1 of sheet SH before the first folding process can be stabilized, regardless of the basis weight or the like of sheet SH, so that the variation of the locations of the first folding lines can be easily (inexpensively) prevented. In particular, when folding guide 4 moves to the folding position P42, the slack LP1 of sheet SH is pushed, to further stabilize the attitude of the slack LP1 of sheet SH before the first folding process.

Further, by providing energization part 32, sheet SH can be prevented from being damaged by folding guide 4 when sheet SH is pushed via the variation of sizes of the slack LP1 of sheet SH.

[Others]

Movable guide 6 may be fixed to closure position P61, and detachable from the main body of post-processing device 51. In this instance, when performing a Z-folding process on a sheet, movable guide 6 may be disengaged.

According to the above-mentioned embodiment, during the second folding process, movable guide 6 has a function as a folding knife which guides a sheet. However, movable guide 6 may not behave as a folding knife (namely, movable guide 6 may not move to the guiding position P63). Further, post-processing device 51 may guide a sheet during the second folding process by a folding knife installed separately from movable guide 6.

Folding guide 4 may be omitted.

As substitute for Z-folding process (three-folding in which areas of 2 planes among the 3 planes are equal), post-processing device 51 may perform three folding process (three-folding in which areas of the 3 planes are equal). Post-processing device 51 may further have a punching function, and a function for a stapling process or the like.

The processes in the above-mentioned embodiments can be performed by software and a hardware circuit. A computer program which executes the processes in the above embodiments can be provided. The program may be provided recorded in recording media of CD-ROMs, flexible disks, hard disks, ROMs, RAMs, memory cards, or the like to users. The program is executed by a computer of a CPU or the like. The program may be downloaded to a device via communication lines like the internet. The processes explained in the above flowcharts and the description are executed by a CPU in line with the program.

Although the present invention has been described and illustrated in detail, it is clearly understood that the same is by way of illustrated and example only and is not to be taken by way limitation, the scope of the present invention being interpreted by terms of the appended claims.

What is claimed is:

1. A post-processing device capable of performing a first and a second folding processes on a sheet, comprising
a pair of conveying rollers installed on a first conveying path for conveying the sheet,
a first pair of folding rollers which is installed at a downstream side of the pair of conveying rollers on the first conveying path, for performing the second folding process on the sheet,
a second pair of folding rollers which is installed on a second conveying path for conveying the sheet, which is branched from the first conveying path between the pair of conveying rollers and the first pair of folding rollers, for performing the first folding process on the sheet, and
a guide part which is installed at a closure position which shuts the first conveying path, for guiding the sheet conveyed from the pair of conveying rollers to the first pair of folding rollers, wherein
the closure position is a position where the guide part shuts the first conveying path against an area between a location which is a nearest location from the first conveying path on a circumference of one roller of the second pair of folding rollers and a location which is a nearest location from the first conveying path on a circumference of another roller of the second pair of folding rollers.

2. The post-processing device according to claim 1, wherein
the guide part is movable between the evacuation position and the closure position, wherein the evacuation position is present at an upstream side of the closure position on the first conveying path, and exposes the first conveying path to at least a part of the area.

3. The post-processing device according to claim 2, wherein
the guide part is present at the closure position when a sheet on which the first and the second folding processes are not performed is conveyed along with the first conveying path, and the guide part is present at the evacuation position when performing the first folding process on a sheet.

4. The post-processing device according to claim 2, wherein
the guide part is movable among a guiding position, the closure position, and the evacuation position, wherein the guiding position is present at a downstream side of the closure position on the first conveying path.

5. The post-processing device according to claim 4, wherein the guide part is present at the guiding position, when performing the second folding process on the sheet.

6. The post-processing device according to claim 4, further comprising
a conveying unit to convey a target sheet on which the first and the second folding processes is to be performed, along with the first conveying path, by rotating the pair of conveying rollers and the first pair of folding rollers, in a state in which the guide part is present at the closure position,
an exposure unit to expose at least a part of the area to the first conveying path, by moving the guide part to the evacuation position, after conveying the target sheet by the conveying unit,
a first folding unit to perform the first folding process on the target sheet, by rotating the second pair of folding rollers, after exposing the first conveying path by the exposure unit,
a first slack forming unit to form a slack on the target sheet, by rotating the pair of conveying rollers, after performing the first folding process by the first folding unit,
a first guide unit to guide the slack of the target sheet to a nip of the first pair of folding rollers, by moving the guide part to the guiding position, after forming the slack by the first slack forming unit, and
a second folding unit to perform the second folding process on the target sheet by rotating the first pair of folding rollers, after guiding the slack of the target sheet by the first guide unit.

7. The post-processing device according to claim 6, wherein
the first guide unit pushes the slack of the target sheet by the guide part, when moving the guide part to the folding position.

8. The post-processing device according to claim 7, further comprising
a first energization part installed between a portion to which the guide part is fixed and the guide part.

9. The post-processing device according to claim 6, further comprising
a folding part, wherein
the folding part is movable between a first folding part position and a second folding part position, wherein the first folding part position is a position at which a leading end of the folding part is present at an opposite side of the first conveying path to a side where the second pair of folding rollers is present, and the second folding part position is a position at which the leading end of the folding part is present at the side where the second pair of folding rollers is present on the first conveying path.

10. The post-processing device according to claim 9, wherein
the conveying unit conveys the target sheet along with the first conveying path, in a state in which the folding part is present at the first folding part position, and the post-processing device further comprising
a second slack forming unit to form a slack on the target sheet, by stopping the first pair of folding rollers, after the target sheet was conveyed by the conveying unit, and
a second guide unit to guide the target sheet to a nip of the second pair of folding rollers, by moving the folding part to the second folding part position, after the slack was formed by the second slack forming unit, wherein
the first folding unit performs the first folding process on the target sheet, after guiding the target sheet by the second guide unit.

11. The post-processing device according to claim 10, wherein
the second guide unit pushes the target sheet by the folding part, when the folding part moves to the first folding part position.

12. The post-processing device according to claim 11, further comprising
a second energization part to energize the folding part in a direction from the first folding part position toward the second folding part position.

13. The post-processing device according to claim 1, further comprising
another conveying unit to convey a non-target sheet which is a sheet on which the first and the second folding processes are not performed along with the first conveying path, by rotating the pair of conveying rollers and the first pair of folding rollers, in a state in which the guide part is present at the closure position.

14. An image forming apparatus comprising
a main body of the image forming apparatus to perform printing on a sheet, and
a post-processing device to perform post-processing on the sheet printed by the main body of the image forming apparatus, wherein
the post-processing device is capable of performing a first and a second folding processes on a sheet, and comprises
a pair of conveying rollers installed on a first conveying path for conveying the sheet,
a first pair of folding rollers which is installed at a downstream side of the pair of conveying rollers on the first conveying path, for performing the second folding process on the sheet,
a second pair of folding rollers which is installed on a second conveying path for conveying the sheet, which is branched from the first conveying path between the pair of conveying rollers and the first pair of folding rollers, for performing the first folding process on the sheet, and
a guide part which is installed at a closure position which shuts the first conveying path, for guiding the sheet conveyed from the pair of conveying rollers to the first pair of folding rollers, wherein
the closure position is a position where the guide part shuts the first conveying path against an area between a location which is a nearest location from the first conveying path on a circumference of one roller of the second pair of folding rollers and a location which is a nearest location from the first conveying path on a circumference of another roller of the second pair of folding rollers.
